(19) United States
(12) Patent Application Publication
(10) Pub. No.: US 2023/0064191 A1
(43) Pub. Date: Mar. 2, 2023

(54) HIGH GROWTH LIGHT SPECTRUM AND FIXTURE

(71) Applicant: LUXX LIGHTING, INC., Mira Loma, CA (US)

(72) Inventors: Paul Morgan Pattison, Johnson City, TN (US); Thomas O'Connor, Pasadena, CA (US); Brandon Burkhart, Stuart, FL (US)

(21) Appl. No.: 17/463,283

(22) Filed: Aug. 31, 2021

(51) Int. Cl. A01G 9/24; A01G 7/04; F21S 4/28

(52) U.S. Cl. CPC A01G 9/249; A01G 7/045; F21S 4/28; F21Y 2115/10

(57) ABSTRACT

An example horticultural lighting fixture disclosed herein includes a first number of light emitting diodes (LEDs) emitting photons in each of a blue spectral band, a green spectral band, and a red spectral band. A second number of LEDs emit photons in the red spectral band. The first number of LEDs and the second number of LEDs collectively emit a number of photons with wavelengths between 400-700 nm, where between 75-85% of the number of photons are emitted in the red spectral band.

### BACKGROUND

Light fixtures may be used to provide energy to biological organisms and systems to promote growth. Particularly, light fixtures provide photosynthetically active radiation to plants to enable photosynthesis and other plant development and growth processes. Some types of light output (e.g., with a high proportion of light in the red portion of the visible spectrum) may contribute to plant growth but may provide an unpleasant, unhealthy, or difficult working environment for humans tending to the plants.

### SUMMARY

An example horticultural lighting fixture disclosed herein includes a first number of light emitting diodes (LEDs) emitting photons in each of a blue spectral band, a green spectral band, and a red spectral band. A second number of LEDs emit photons in the red spectral band. The first number of LEDs and the second number of LEDs collectively emit a number of photons with wavelengths between 400-700 nm, where between 75-85% of the number of photons are emitted in the red spectral band.

Another example horticultural lighting fixture includes a first number of LEDs having a correlated color temperature of between 4,000-6,700 K and a second number of LEDs, where the second number of LEDs are monochromatic with peak emissions between 620-700 nm. A ratio of photon output of the first number of LEDs to a photon output of the second number of LEDs is between 0.3-0.7.

An example method disclosed herein includes distributing a plurality of plants within a grow area having a length and width. The method further includes providing lighting distributed across the grow area, where the lighting has a color temperature of between 2,000-2,400K and is provided using a first number of LEDs having a color temperature of between 5,000-6,700K and a second number of LEDs. The second number of LEDs are monochromatic with peak emissions between 620-700 nm.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE DRAWINGS

The description will be more fully understood with reference to the following figures in which components are not drawn to scale, which are presented as various examples of the present disclosure and should not be construed as a complete recitation of the scope of the disclosure, characterized in that:

FIG. 1 illustrates an example horticultural lighting fixture providing light for growth of plants within a growth area.

FIG. 2 illustrates an example lighting element of an example horticultural lighting fixture.

FIG. 3 illustrates example spectrums for LEDs of a horticultural lighting fixture.

FIG. 4 illustrates an example spectrum of light emitted from a horticultural lighting fixture.

FIG. 5 is a flow diagram of operations for providing lighting for growth of plants within a growth area.

### DETAILED DESCRIPTION

Plants generally utilize light within certain portions (e.g., between 400-700 nm) of the electromagnetic spectrum to photosynthesize. Photons emitted within these portions of the electromagnetic spectrum (e.g., having wavelengths between 400-700 nm) may be referred to as photosynthetically active photons. Growing plants in indoor or other low natural light environments generally utilizes horticultural lighting fixtures to emit such photosynthetically active photons to facilitate plant growth. While some horticultural lighting fixtures are designed to mimic sunlight, varying the spectrum provided to plants during growth may positively affect plant growth, such as by providing quicker, heathier, and/or more efficient (e.g., more growth per input power) plant growth.

For example, plants grown in indoor environments generally respond well to red light, such that many horticultural lighting fixtures are created to emit a large amount of light within the red spectrum. For example, many types of plants show increased growth, better root structure, and other positive qualities when grown under lighting including a large number of photosynthetically active photons having wavelengths corresponding to red light. Several types of lighting fixtures may be used to emit larger amounts of red light. Often, such lighting fixtures include a combination of blue and red lighting elements (e.g., LEDs) to generate the desired light characteristics. Such lighting fixtures may cause difficulties for humans tending to plants grown with the lighting fixtures, including difficulty with visual function. For example, human visual acuity may be decreased without some portions of light corresponding to possible colors in the visible spectrum as humans generally perceive the color of an object based on colors of light reflected off of the object. Working in such conditions may be uncomfortable for workers and cause physical symptoms, such as headaches or eye strain.

Several types of horticultural light fixtures may be used to generate “full spectrum” light to address the difficulties posed by lighting fixtures including combinations of red and blue LEDs. A full spectrum generally includes light in each portion of the visible spectrum, and a full spectrum light fixture generally emits photons having wavelengths corresponding to the wavelengths of the visual spectrum. Some full spectrum lights may use high pressure sodium (HPS) lighting elements, which are generally more expensive and less efficient (e.g., less photon output per input electric watt) than LEDs. Some full spectrum light fixtures include combinations of various shades of monochromatic LEDs to obtain a full spectrum. However, monochromatic LEDs may be placed in a consolidated area in the light fixture as placing the monochromatic LEDs too far apart may result in inconsistent light across the light fixture. Consolidated placement of LEDs may generate more heat output, such that additional cooling (e.g., fans, liquid circulating coolant) may be needed for operation of the light fixture. Accordingly, current full spectrum options may be relatively expensive and inefficient.

In various examples, the horticultural lighting fixture disclosed herein provides full spectrum light with a large portion (e.g., between 75-85%) of light emitted in the red band using a combination of white LEDs and red LEDs. White LEDs and red LEDs may be used to generate full spectrum light, as white LEDs emit photons in each of the red, blue, and green spectral bands. Using white LEDs, lighting elements may be spaced further apart from one another than monochromatic LEDs, such that less heat is generated by the lighting fixture. Further, white LEDs are generally readily available, so the lighting fixture may be less expensive to produce and simpler to repair than alternative full spectrum fixtures. The spectrum of light provided by the lighting fixture described herein may also provide a different spectrum (e.g., different relative light intensities at various wavelengths in the electromagnetic spectrum) than other available full spectrum lights and may result in improved plant growth for various types of plants.

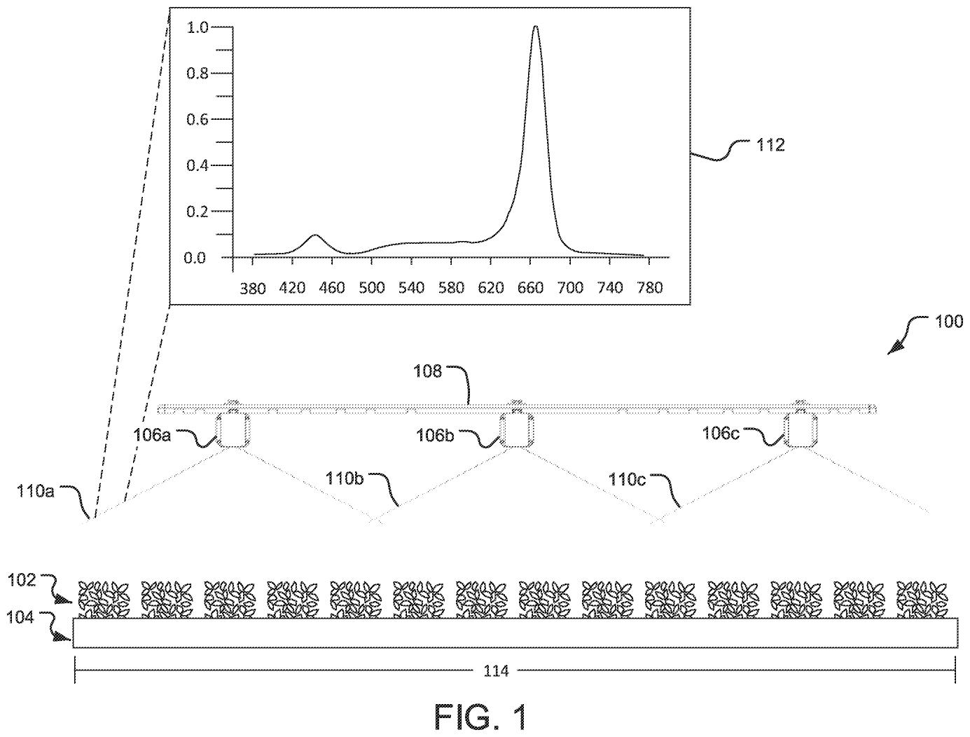

Various embodiments of the present disclosure will be explained below in detail with reference to the accompanying drawings. Other embodiments may be utilized, and structural, logical and electrical changes may be made without departing from the scope of the present disclosure. FIG. 1 illustrates an example lighting fixture 100 providing light for growth of plants 102 within a growth area 104. The lighting fixture 100 includes lighting elements 106a-106c each removably connected to a bracket 108 to collectively form the lighting fixture 100. The bracket 108 may be permanently or removably mounted (e.g., to a ceiling, wall, or other structure) or may be free standing. In some examples, lighting elements 106a-106c may be mounted and/or positioned without use of the bracket 108. For example, each of the lighting elements may be individually suspended from a ceiling or strut mounted to a ceiling. The lighting elements 106a-106c may further include support structures (e.g., a movable base) and may be positioned accordingly over the growth area 104. The growth area 104 may vary in size and shape. In some embodiments, the grow area 104 is generally rectangular with a length of between 42-54 inches and a width of between 1-4 inches. In some examples, the grow area 104 may be defined by a container, shelf, or other structure, such as a tray for plants within the grow area 104.

The lighting fixture 100 may be implemented using structures described in U.S. patent application Ser. No. 17/245,560, filed Apr. 30, 2021 and entitled “Mounting Bracket System for Light Fixtures,” which is incorporated by reference herein for any purpose. In some examples, the lighting fixture 100 may be implemented using different lighting structures, including light fixtures with single lighting elements.

The lighting elements 106a-106c emit light 110a-110c, respectively. Light 110a-110c may be emitting from illuminable elements (e.g., LEDs) provided on a surface of the lighting elements 106a-106c directed to the growth area 104. The illuminable elements may be placed on the surfaces of the lighting elements 106a-106c and the lighting elements 106a-106c may be placed such that light 110a-110c is evenly or substantially evenly distributed over a width 114 of the growth area 104 and a length of the growth area 104 perpendicular to the width 114. For example, LEDs may have a light spread defining an area illuminated by light produced by the LEDs. LEDs may be distributed across the surfaces of the lighting elements 106a-106c such that the light 110a-110c produced by the lighting elements 106a-106c is distributed across the length and width 114 of the growth area 104.

Spectrum 112 shows an example spectrum of light 110a emitted by the lighting element 106a. Light 110b and 110c emitted by the lighting elements 106b and 106c, respectively, may have similar or identical spectra. Spectrum 112 shows the relative radiant power emission for each wavelength from 380 nm-780 nm. As shown, the spectrum 112 may be full spectrum in that the spectrum includes some emissions across the spectrum of visible light (e.g., between about 380-700 nm) and within the photosynthetically active photon range (e.g., between 400-700 nm). Spectrum 112 has peak emissions at about 600 nm, which correlates to light in the red portion of the spectrum. Accordingly, the spectrum 112 of light emitted by the lighting fixture 100 is full spectrum, with a large portion of photons emitted (e.g., between 75-85%) at wavelengths corresponding to red lighting, providing improved plant growth. Spectrum 112 may be measured at a spectral plane spaced from the lighting fixture 100. For example, the spectral plane may be a plane defined by the length and width of the grow area 104. The distance of the spectral plane from the lighting fixture 100 may vary in different embodiments of the lighting fixture 100.

The lighting fixture 100 may emit light as shown in the spectrum 112 responsive to a provided power input. As LEDs may be used to provide lighting and plants generally respond well to the provided light, the lighting fixture 100 may have a relatively high efficiency (e.g., the amount of photons output per watt input, the amount of photosynthetic photons output per watt input, and/or the amount of plant growth achieved per watt input). For example, the lighting fixture 100 may be configured to receive an electrical input of between 150-300 watts and may have a photosynthetic photon efficacy of between 2.5-3.5 μmol of emitted photons per second per applied input electrical watt. In some examples, the lighting fixture 100 may be configured to receive 200 watts of input electrical power. Other values for input power are also used, such as, for example 18 watts or 1000 watts of input electrical power.

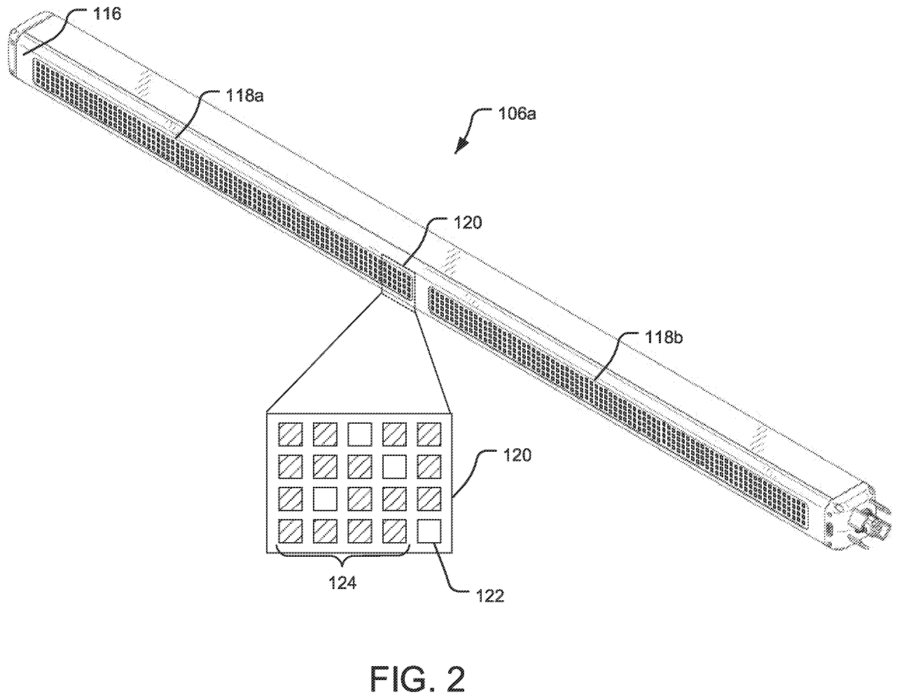

FIG. 2 illustrates an example lighting element 106a of the lighting fixture 100. The lighting element 106a includes a planar surface 116 which, when the lighting element 106a is arranged as shown in FIG. 1, is generally parallel to the growth area 104. A first opening 118a in the surface 116 and a second opening 118b in the surface 116 may each accommodate LEDs. Though the lighting element 106a is shown with two openings, in various embodiments, the surface 116 may include more or fewer openings. In some examples, the surface 116 may include one opening for LEDs. In some examples, the surface 116 may include many openings, e.g., by including an opening for each LED of the lighting element 106a. In some examples, the openings 118a and b may be covered or filled in by a translucent or transparent material, such as glass, plastic, or the like.

Inset 120 shows a sample of LED placement in the opening 118a. Inset 120 shows two sets of LEDs, a first set of LEDs 122 shown as white squares and a second set of LEDs 124 shown as hatched squares. In various examples, the first set of LEDs 122 may be white LEDs, generally emitting light in each of a blue, green, and red band of the visible light spectrum. The second set of LEDs 124 may be monochromatic LEDs, emitting light in the red band of the visible light spectrum.

The first type of LEDs 122 may be, in some examples, white LEDs having a correlated color temperature between 4,000-7,000 K. The white LEDs 122 will, generally, emit light in both the blue and green spectra, with a smaller amount of light being emitted in the red spectrum. The color temperature of the light produced by the white LEDs 122 may be selected to match the desired proportions of green light and blue light emitted by the white LEDs 122. For example, the white LEDs 122 may have a correlated color temperature of 6500 K and a color rendering index of 70. In other examples, the white LEDs may have a correlated color temperature of 5,000 K or 6,200 K. Further, the first type of white LEDs 122 may include different sub-types of white LEDs (e.g., a portion of the first type of LEDs 122 may have a correlated color temperature of 6,500 K and a second portion of the first type of LEDs 122 may have a correlated color temperature of 6,200 K). The second type of LEDs 124 may be monochromatic LEDs with peak emissions between 620-700 nm. Accordingly, the second type of LEDs 124 may emit photons correlating to red visible light. In some examples the second type of LEDs 124 may have peak emissions at 660 nm.

The first number of the first type of LEDs and the second number of the second type of LEDs may be placed within the opening 118a and the opening 118b such that the light provided by the lighting fixture 106a is substantially uniform. For example, as shown in the inset 120, the first type of LEDs 122 may be distributed among the second type of LEDs 124 (e.g., in each row or column of LEDs). In some examples, the placement of the first type of LEDs 122 may follow a set pattern to create uniform lighting by the lighting element 106a. For example, LEDs may be place within the first opening 118a in a grid pattern, such that the LEDs are arranged in aligned rows and columns. White LEDs 122 may be provided in each column or row of LEDs within the pattern such that the white LEDs 122 are roughly evenly distributed among the second type of red LEDs 124. In some examples, white LEDs may be placed among the monochromatic second type of LEDs 124 in specific placements experimentally determined to provide roughly uniform light from the lighting element 106a at a spectrum plane spaced a distance from the lighting fixture 100

While the LEDs are shown arranged in a grid pattern (e.g., parallel columns of LEDs extending longitudinally relative to the length of the light fixture and parallel rows of LEDs intersecting the columns at perpendicular orientations) within the first opening 118a and the second opening 118b, other patterns are possible and other grid patterns may include different numbers of rows and columns within the opening 118a and the 118b and/or different numbers of LEDs in each row and column. For example, in some embodiments, the LEDs may be arranged in columns and rows offset from adjacent rows and/or columns such that the LEDs are diagonally aligned with each other relative to the edges of the openings 118a and 118b. Rows may, for example, extend longitudinally relative to the length of the light fixture, with the columns intersecting at perpendicular orientations relative to the columns, forming the grid. In some examples, the LEDs may be arranged in a grid pattern with, for example, more space between columns of LEDs than between rows of LEDs.

Generally, the ratio of the number of the first type LEDs 122 to the number of the second type of LEDs 124 may be selected such that the light output by the lighting element 106a is full spectrum light including a large portion (e.g., larger than 50%) of emissions in the red spectral band. Accordingly, the ratio may be selected based on desired characteristics of the light collectively output by the first type of LEDs 122 and the second type LEDs 124. For example, the number of first LEDs 122 and the number of second LEDs 124 may be selected such that between 75-85% of photons output by the lighting element 106a between 400-700 nm have wavelengths corresponding to the red spectral band (e.g., between 600-700 nm). The desired light output may also, in some examples, be expressed as a percentage of light output in each of the blue, green, and red spectral bands. For example, the lighting element 106a may output 80% of photons in the red spectrum, 14% of photons in the green spectrum, and 7% of photons in the blue spectrum. In some examples, the number of first LEDs 122 and the number of second LEDs 124 may be selected such that the correlated color temperature of light emitted by the lighting element 106a is between 2,000-2,400 K and a color rendering index of greater than 25. In some examples, the ratio of photon output of the first number of LEDs to the ratio of photon output of the second number of LEDs is between 0.3-0.7 to achieve the desired light output.

In some examples, to obtain the desired light output of the lighting element 106a, the second type of LEDs 124 may make up about 80% of the total number of LEDs in the lighting element 106a and the first type of LEDs 122 may make up about 20% of the total number of LEDs in the lighting element 106a. In various examples, the second number of LEDs may make up between 60-90% or 75-85% of the total number of LEDs in the lighting element 106a. In some examples, the number of second red LEDs 124 may be approximately four times the number of first white LEDs 122 in the lighting element 106a or the lighting fixture 100, regardless of the total number of LEDs provided in the lighting element 106a. The ratio between the first type of LEDs 122 and the second type of LEDs 124 may vary based on, for example, characteristics of the LEDs used. For example, where the first type of white LEDs 122 have a higher output (e.g., provide a higher intensity light) than the red LEDs 124, fewer white LEDs 122 may be used relative to the number of red LEDs 124. The ratio of white LEDs 122 to red LEDs 124 may also be adjusted based on desired light characteristics, other lighting elements included in the lighting element 106a, and various other factors in some examples.

In some examples, the lighting element 106a may include a number of a third type of LEDs emitting photons with wavelengths between 700-750 nm. The specifications and number of the third type of LEDs may be selected such that the photons emitted by the third type LEDs (e.g., those with wavelengths between 700-750 nm) are up to 30% of the photons emitted by the element 106a between 400-750 nm. The third type of LEDs may be placed among the first type of LEDs 122 and the second type of LEDs 124 such that the light provided by the lighting element 106a is roughly uniform.

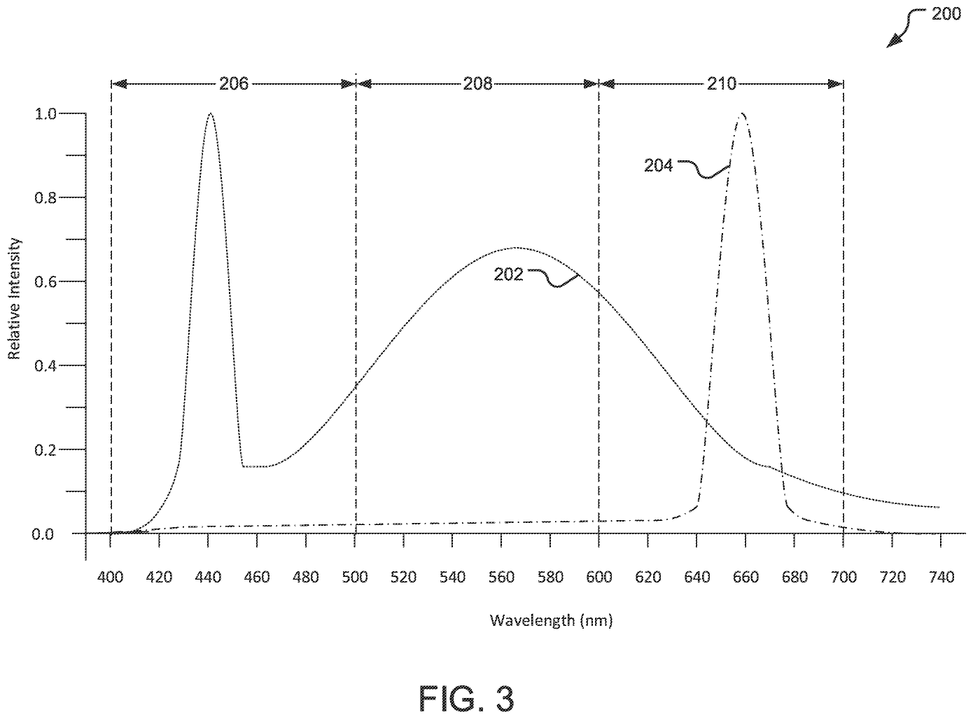

FIG. 3 illustrates example spectrums 200 for LEDs of the horticultural lighting fixture 100. A curve 202 shows the relative intensity of light emitted by a first type of LED (e.g., the white LEDs 122) that may be used in the horticultural lighting fixture 100, and a curve 204 shows the relative intensity of light emitted by a second type of LED (e.g., the red LEDs 124) that may be used in the horticultural lighting fixture. The example spectrums 200 are shown divided into three spectral bands 206, 208, and 210. The spectral band 206 may extend from approximately 400-499 nm and may be referred to as a blue spectral band. The spectral band 208 may extend from approximately 500-599 nm and may be referred to as a green spectral band. The spectral band 210 may extend from approximately 600-700 nm and may be referred to as a red spectral band. Photons emitted in the spectral band 206 (e.g., photons have frequencies correlating to wavelengths in the spectral band 206) may provide varying shades of blue light as visible light. Similarly photons emitted in the spectral band 208 may provide various shades green light as visible light and photons emitted in the spectral band 210 may provide various shades of red light. Collectively, photons emitted in the portion of the electromagnetic spectrum between 400-700 nm may be referred to as photosynthetic photons, as plants generally utilize light in this portion of the spectrum to carry out photosynthesis.

The curve 202 shows light output from the first white LEDs 122, in some examples. As shown, the white LEDs may emit photons in each of the first spectral band 206 (e.g., the blue spectrum), the second spectral band 208 (e.g., the green spectrum), and the third spectral band 210 (e.g., the red spectrum). The white LEDs may, for example, exhibit peak emissions in the first spectral band 206 (e.g., the highest relative intensity is at a wavelength in the blue spectral band). The white LEDs may also emit a larger number of total photons in the second spectral band 208. In some examples, the number of photons emitted in the second (green) spectral band 208 may be greater than or equal to the number of photons emitted in the first (blue) spectral band 206. The curve 202 may vary in some examples, depending on the characteristics of the white LEDs 122 selected.

The curve 204 shows light output from the second red LEDs 124, in some examples. The red LEDs 124 may be monochromatic, meaning that the vast majority of photons emitted by the red LEDs 124 are within the third (red) spectral band 210. The curve 204 is shown with peak emissions at about 660 nm, though peak emissions of the red LEDs 124 may vary in some examples. Generally, as the red LEDs emit, at most, negligible light in the first (blue) spectral band 206 and the second (green) spectral band 208, the proportions of blue and green light in the lighting fixture 100 may be based on characteristics of the white LEDs 122. Accordingly, in various examples, the white LEDs 122 may be selected based on the desired proportions of blue and green spectral emissions in the spectrum 112 of the horticultural light 100.

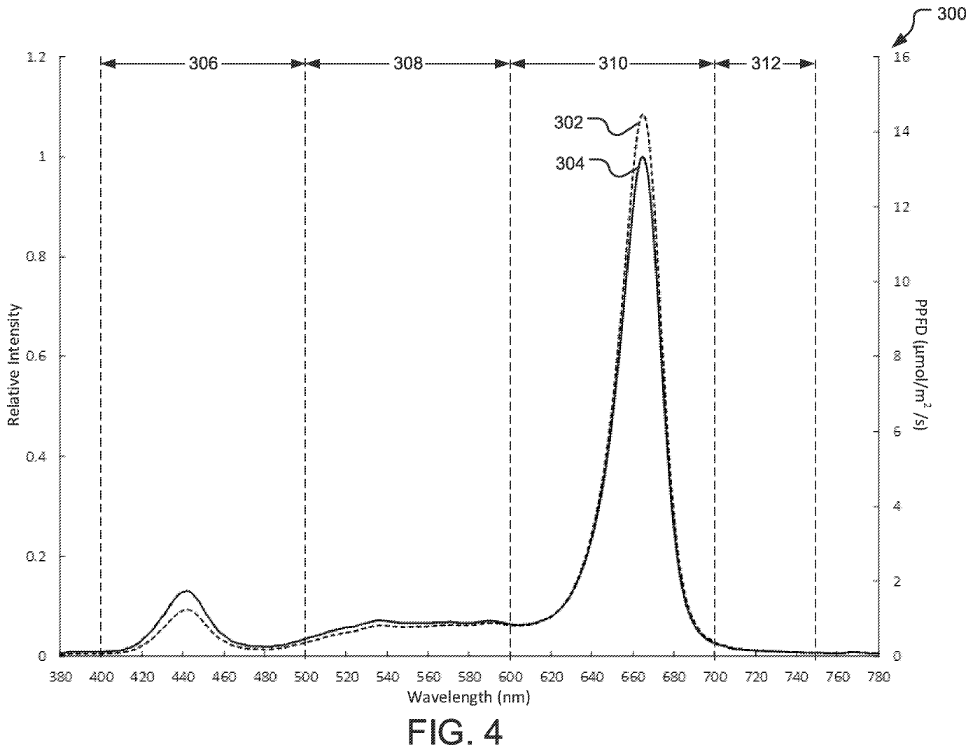

FIG. 4 illustrates an example spectrum 300 of light emitted from the horticultural lighting fixture 100. The spectrum 300 is shown including four spectral bands 306, 308, 310, and 312. The first spectral band 306 includes wavelengths from 400-499 nm, correlating roughly to blue visible light. The second spectral band 308 includes wavelengths from 500-599 nm, correlating roughly to green visible light. The third spectral band 310 includes wavelengths from 600-699 nm, correlating to red visible light. The fourth spectral band 312 includes wavelengths from 700-750 nm, which may correlate to low frequency infrared emissions.

The spectrum 300 includes a first curve 302 showing the photosynthetic photon flux density (PPFD) of the emitted light in mol/m²/second. The PPFD roughly correlated to the number of photosynthetic photons emitted by the lighting fixture 100 per unit area per second at each wavelength included in the spectrum 300. As shown, the lighting fixture 100 may emit more total photons in the third (red) spectral band 310 than in the other spectral bands included in the spectrum 300, peaking at around 660 nm. Accordingly, the lighting fixture 100 may emit a high proportion of photons (e.g., between 75-85%) in the third (red) spectral band 310. In some examples, the peak wavelength may vary within the red spectral band 310. The photons emitted in the third (red) spectral band may be largely emitted from the red LEDs 124, with a small portion being emitted from the white LEDs 122, depending on the characteristics of the white LEDs 122 used in the lighting fixture 100. While the white LEDs 122 may emit some photons in the red spectral band 310, the wavelength of the peak emission of the lighting fixture 100 may correlate with the peak emissions of the red LEDs 124. The proportions of photons emitted in the first spectral band 306 and the second spectral band 308 may correlate to the characteristics of the white LEDs 122. For example, the peak emissions within the first spectral band 306 and the second spectral band 308 may correlated to the peak emissions of the white LEDs 122 within the blue and green spectral bands, respectively.

In some examples, the spectrum of light emitted by the lighting fixture 100 may vary from the spectrum 300. For example, some embodiments may include a number of a third type of LEDs emitting photons in the fourth spectral band 312. In such embodiments, a higher portion of photons in the spectrum 300 may be emitted in the fourth spectral band 312. In some examples, the white LEDs may include white LEDs with different spectra, affecting the photons emitted in the first spectral band 306 and the second spectral band 308. In some examples, the red LEDs may include red LEDs with different peak emissions, such that the light emitted by the lighting fixture 100 may include high relative intensity and PPFD at two different wavelengths in the third (red) spectral band 310.

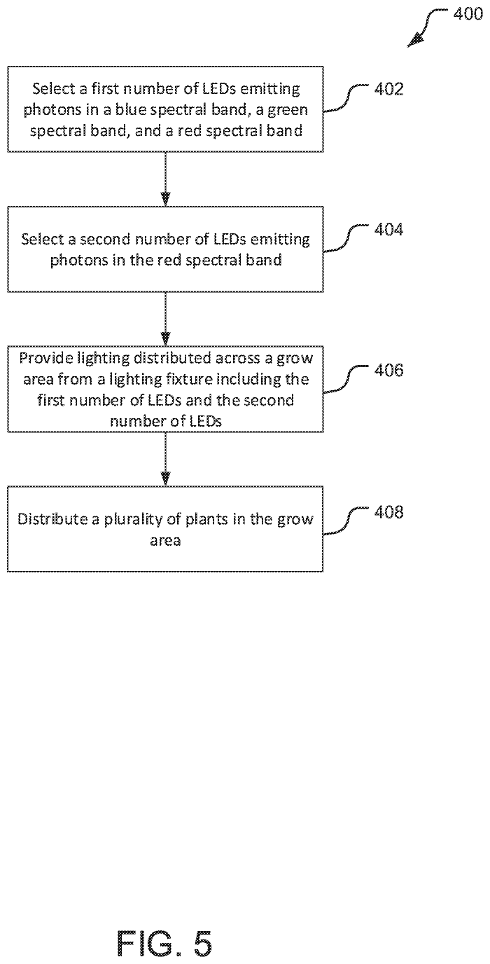

FIG. 5 is a flow diagram of operations 400 for providing lighting for growth of plants within a growth area. In a first selection operation 402, a first type of LEDs are selected, where the first type of LEDs emit photons in a blue spectral band, a green spectral band, and a red spectral band. The first type LEDs 122 may be white LEDs. The white LEDs may be selected based on the desired ratios of photon emission in the blue and green spectral bands, and may emit relatively smaller numbers of photons in the red spectral band. Accordingly, the first type LEDs may generally have correlated color temperatures between 4,000-6,700 K. In some examples, the first selection operation 402 may further include selected two or more different sub-types of white LEDs as the first LEDs. For example, the first type of LEDs 122 may include LEDs having correlated color temperatures of 5,000K, 6,200 K, and 6,500 K. In some examples, the amount of first LEDs may be selected such that the number of photons emitted by the first type of LEDs in the green spectral band is greater than or equal to the number of photons emitted by the first type of LEDs in the blue spectral band.

In a second selection operation 404, a second type of LEDs are selected, where the second type of LEDs 124 emit photons in the red spectral band. The second type of LEDs 124 may be monochromatic LEDs with peak emissions in the red spectral band (e.g., between 600-700 nm). For example, the second type of LEDs 124 may have peak emissions around 660 nm. In some examples, the second type of LEDs 124 may include two sub-types of LEDs having peak emissions at different wavelengths within the red spectral band. For example, the number of second LEDs may include red LEDs with peak emissions at 620 nm and red LEDs with peak emissions at 660 nm.

In some examples, the operations 400 may include additional operations to determine the amount of white LEDs 122 and the amount of red LEDs 124 to include in a lighting fixture 100. The amount of white LEDs 122 may be determined relative to the amount of red LEDs 124 based on desired characteristics (e.g., the number of photons emitted at various wavelengths) of the light output by the lighting fixture 100. The operations 400 may also include determining the placement of the white LEDs 122 and the red LEDs 124 within the lighting fixture 100 such that the light provided by the lighting fixture 100 is relatively uniform across a grow area 104 illuminated by the lighting fixture. Placement of the white LEDs 122 relative to (e.g., distributed among) the red LEDs as well as spacing between the LEDs in the lighting fixture 100 may, in some examples, be determined experimentally.

In operation 406, lighting is provided by a lighting fixture 100 including the first type of LEDs 122 and the second type of LEDs 124. The lighting is distributed across a grow area 104. In some examples, the lighting fixture 100 may be sized and/or configured such that the light emitted by the lighting fixture 100 is distributed across a particular grow area 104. For example, more lighting elements (e.g., 106a and 106b) may be added to the lighting fixture 100 to expand the grow area 104 illuminated by the lighting fixture 100. Lighting may be provided by the lighting fixture 100 by supplying electrical power to the lighting fixture 100 through cords, batteries, and the like.

In operation 408, a plurality of plants are distributed in the grow area 104. In some examples, the lighting fixture 100 may be connected to a controller or other mechanism to adjust the lighting fixture 100 in accordance with varying needs of the plants within the grow area 104. For example, the lighting fixture 100 may be dimmed or brightened at preset times of day to benefit the plants within the grow area 104. In some examples, such settings may be adjusted based on desired characteristics of the plants being grown (e.g., taste, nutrient or other content) or the types of plants being grown using the light emitted by the lighting fixture 100.

The above specification, examples and data provide a complete description of the structure and use of exemplary embodiments of the invention as defined in the claims. Although various embodiments of the claimed invention have been described above with a certain degree of particularity, or with reference to one or more individual embodiments, it is appreciated that numerous alterations to the disclosed embodiments without departing from the spirit or scope of the claimed invention may be possible. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A horticultural lighting fixture comprising:
a first number of light emitting diodes (LEDs) emitting photons in each of a blue spectral band, a green spectral band, and a red spectral band;
a second number of LEDs emitting photons in the red spectral band; and
wherein the first number of LEDs and the second number of LEDs collectively emit a number of photons with wavelengths between 400-700 nm, wherein between 75-85% of the number of photons are emitted in the red spectral band.

2. The horticultural lighting fixture of claim 1, wherein a first portion of the number of photons emitted in the green spectral band is greater than or equal to a second portion of the number of photons emitted in the blue spectral band.

3. The horticultural lighting fixture of claim 1, wherein the red spectral band correlates to wavelengths between 600-700 nm.

4. The horticultural lighting fixture of claim 1, wherein the first number of white LEDs and the second number of red LEDs collectively emit between 400-1000 μmol per second of photosynthetic photons.

5. The horticultural lighting fixture of claim 1, wherein a photosynthetic photon efficacy of the number of photons emitted is between 2.5-3.5 μmol of emitted photons per second per applied input electrical watt.

6. The horticultural lighting fixture of claim 5, wherein the input electrical power to the horticultural lighting fixture is between 150-300 watts.

7. The horticultural lighting fixture of claim 1, further comprising a third number of LEDs emitting photons with wavelengths between 700-750 nm, such that the photons with wavelengths between 700-750 nm comprise up to 30% of photons emitted by the horticultural lighting fixture with wavelengths between 400-750 nm.

8. The horticultural lighting fixture of claim 1, wherein light emitted by the horticultural lighting fixture has a color rendering index (CRI) of greater than 25.

9. A horticultural lighting fixture comprising:
a first number of light emitting diodes (LEDs) having a correlated color temperature of between 4,000-6,700 K;
a second number of LEDs, wherein the second number of LEDs are monochromatic with peak emissions between 620-700 nm; and
wherein a ratio of photon output of the first number of LEDs to a photon output of the second number of LEDs is between 0.3-0.7.

10. The horticultural lighting fixture of claim 9, wherein the ratio of the photon output of the first number of LEDs to the second number of LEDs is determined such that the lighting fixture overall emits light having a correlated color temperature of between 2,000-2,400 K.

11. The horticultural lighting fixture of claim 9, wherein the first number of LEDs emit photons in each of a first spectral band between 400-499 nm, a second spectral band between 500-599 nm, and a third spectral band between 600-700 nm.

12. The horticultural lighting fixture of claim 9, wherein a photosynthetic photon output of the horticultural lighting fixture includes photons of the photon output of the first number of LEDs having wavelengths between 400-700 nm and photons of the photon output of the second number of LEDs having wavelengths between 400-700 nm, wherein between 75-85% of photons of the photosynthetic photon output have wavelengths between 600-700 nm.

13. The horticultural lighting fixture of claim 9, wherein the first number of LEDs and the second number of LEDs collectively emit between 400-1000 μmol per second of photosynthetic photons.

14. The horticultural lighting fixture of claim 9, further comprising a third number of LEDs emitting photons in a spectral band between 700-750 nm, such that the photons in the spectral band comprise up to 30% of photos emitted by the horticultural lighting fixture between 400-750 nm.

15. A method comprising:
distributing a plurality of plants within a grow area, the grow area having a length and a width; and
providing lighting distributed across the grow area, the lighting having a color temperature of between 2,000-2,400K, wherein the lighting is provided using a first number of light emitting diodes (LEDs) having a color temperature of between 5,000-6,700K and a second number of LEDs, wherein the second number of LEDs are monochromatic with peak emissions between 620-700 nm.

16. The method of claim 15, wherein the length of the grow area is between 42-54 inches and the width of the growth area is between 1-4 inches.

17. The method of claim 15, wherein the lighting distributed across the grow area is emitted by a lighting fixture emitting a photon composition with emissions between 400-700 nm, wherein between 75-85% of the photon composition is emitted between 600-700 nm.

18. The method of claim 15, wherein the lighting distributed across the grow area is emitted by a lighting fixture having a photosynthetic photon efficacy of between 2.5-3.5 μmol/second watt.

19. The method of claim 18, further comprising providing an input power to the lighting fixture of between 150-300 watts.

20. The method of claim 15, wherein the second number of LEDs have peak emissions at 660 nm.
